(19) United States
(12) Patent Application Publication
(10) Pub. No.: US 2025/0329485 A1
(43) Pub. Date: Oct. 23, 2025

(54) SOFT MAGNETIC MATERIAL AND METHOD OF PRODUCING SOFT MAGNETIC MATERIAL

(71) Applicant: NICHIA CORPORATION, Anan-shi (JP)

(72) Inventors: Satoshi ABE, Anan-shi (JP); Ryoya OKAZAKI, Anan-shi (JP); Jun NISHITSUJI, Anan-shi (JP); Jun AKAMATSU, Tokushima-shi (JP); Nobuyoshi IMAOKA, Anan-shi (JP)

(73) Assignee: NICHIA CORPORATION, Anan-shi (JP)

(21) Appl. No.: 19/184,574

(22) Filed: Apr. 21, 2025

(30) Foreign Application Priority Data
Apr. 22, 2024 (JP) 2024-069277
Dec. 6, 2024 (JP) 2024-213420

(51) Int. Cl. H01F 1/20; H01F 1/147; H02K 1/02; H02K 1/12

(52) U.S. Cl. CPC H01F 1/20; H01F 1/14733; H02K 1/02; H02K 1/12

(57) ABSTRACT

A method of producing a soft magnetic material includes spray drying a slurry containing Fe and X to obtain granules having an average particle size in a range of at least 20 μm but not more than 200 μm, where X represents at least one element selected from the group consisting of Ti, Mn, Ni, Co, Zr, Hf, V, Nb, Ta, Cr, Mo, W, Cu, Zn, and Si; and heat-treating the granules in a reducing gas at a temperature in a range of at least 800° C. but not higher than 1200° C. to obtain a heat-treated product.

### CROSS-REFERENCE TO RELATED PATENT APPLICATION

This application claims priority to Japanese Patent Application No. 2024-069277 filed on Apr. 22, 2024 and Japanese Patent Application No. 2024-213420 filed on Dec. 6, 2024. The disclosures of Japanese Patent Application No. 2024-069277 and Japanese Patent Application No. 2024-213420 are hereby incorporated by reference in their entirety.

### BACKGROUND

The present disclosure relates to a soft magnetic material and a method of producing the soft magnetic material.

Soft magnetic materials are known as magnetic core materials for electrical devices such as motors and transformers (see WO 2017/164376 and WO 2018/155608). In particular, there is a need for soft magnetic powders with good high-frequency characteristics for the development of high-frequency (e.g., 2 kHz or higher) axial motors. The problem with conventional soft magnetic powders is that magnetic bodies produced from these soft magnetic powders, i.e., molded magnetic products, suffer from high iron loss because eddy currents can be generated throughout the component due to the conduction between the particles.

### SUMMARY

Certain embodiments of the present disclosure aim to provide a soft magnetic material having a small average particle size, a high circularity, and a low degree of necking and thus having low iron loss, and a method of producing the soft magnetic material.

According to an aspect of the present disclosure, a method of producing a soft magnetic material includes: spray drying a slurry containing Fe and X to obtain granules having an average particle size in a range of at least 20 μm but not more than 200 μm, wherein X represents at least one element selected from the group consisting of Ti, Mn, Ni, Co, Zr, Hf, V, Nb, Ta, Cr, Mo, W, Cu, Zn, and Si; and heat-treating the granules in a reducing gas at a temperature in a range of at least 800° C. but not higher than 1200° C. to obtain a heat-treated product.

According to an aspect of the present disclosure, a soft magnetic material includes a first phase and a second phase each including crystals with a bcc structure containing Fe and X, wherein X represents at least one element selected from the group consisting of Ti, Mn, Zr, Hf, V, Nb, Ta, Cr, Mo, W, Cu, Zn, and Si, at least one element of the at least one element represented by X is contained in both the first phase and the second phase, an amount of one of the at least one element in the second phase is at least twice but not more than 10⁵ times an amount of the one of the at least one element in the first phase, and the soft magnetic material has an average circularity in a range of at least 0.55 and an average particle size in a range of 160 μm or less.

According to an aspect of the present disclosure, a soft magnetic material includes a first phase and a second phase each including crystals with a bcc structure containing Fe and X, wherein X represents at least one transition metal selected from the group consisting of Ni and Co, at least one element of the at least one transition metal represented by X is contained in both the first phase and the second phase, an amount of one of the at least one element in the second phase is more than one time but not more than 10⁵ times an amount of the one of the at least one element in the first phase, and the soft magnetic material has an average circularity in a range of at least 0.55 and an average particle size in a range of 160 μm or less.

According to certain embodiments of the present disclosure, a soft magnetic material having a small average particle size, a high circularity, and a low degree of necking and a method of producing the soft magnetic material can be provided, thereby enabling the production of magnetic materials having low iron loss even at high frequencies. In particular, certain embodiments of the present disclosure relate to a metal-based soft magnetic material, such as a Fe—X soft magnetic material, with a high magnetization, a high flux density, and a high magnetic permeability.

### BRIEF DESCRIPTION OF DRAWINGS

FIG. 1A shows a scanning electron microscope (SEM) image of a magnetic powder prepared in Example 4.

FIG. 1B shows the SEM image of the magnetic powder prepared in Example 4 and Ni concentrations at different points quantified by energy dispersive X-ray fluorescence analysis (EDX).

FIG. 1C shows the SEM image of the magnetic powder prepared in Example 4 and Mn concentrations at the different points quantified by EDX.

FIG. 2 shows an X-ray diffraction (XRD) pattern of the magnetic powder prepared in Example 4.

FIG. 3A shows an SEM image of a magnetic powder prepared in Example 7.

FIG. 3B shows the SEM image of the magnetic powder prepared in Example 7 and Ni concentrations at different points quantified by EDX.

FIG. 3C shows the SEM image of the magnetic powder prepared in Example 7 and Mn concentrations at the different points quantified by EDX.

FIG. 4 shows an XRD pattern of the magnetic powder prepared in Example 7.

FIG. 5A shows a scanning transmission electron microscope (STEM)-high-angle annular dark field (HAADF) image and STEM-EDX mapping images of a cross-section of the magnetic powder prepared in Example 7.

FIG. 5B shows Ni and Mn concentration profiles along the lines shown in FIG. 5A.

### DETAILED DESCRIPTION

Certain embodiments of the present disclosure are described in detail below. The following embodiments, however, are intended as examples to embody the technical idea of the present disclosure and are not intended to limit the scope of the present disclosure to the following embodiments. In the present specification, the term “step” encompasses not only an independent step but also a step that may not be clearly distinguished from other steps, as long as a desired object of the step is achieved.

Moreover, numerical ranges indicated using “to” refer to ranges including the numerical values before and after “to” as the minimum and maximum, respectively.

### Method of Producing Soft Magnetic Material

A method of producing a soft magnetic material according to one embodiment of the present disclosure includes spray drying a slurry containing Fe and X to obtain granules having an average particle size of at least 20 μm but not more than 200 μm, wherein X represents at least one element selected from the group consisting of Ti, Mn, Ni, Co, Zr, Hf, V, Nb, Ta, Cr, Mo, W, Cu, Zn, and Si; and heat-treating the granules in a reducing gas at a temperature of at least 800° C. but not higher than 1200° C. to obtain a heat-treated product.

A metal-based soft magnetic material as a Fe—X soft magnetic material according to the present embodiment can also be produced by a method which includes, instead of spray drying a Mn—Ni-ferrite-containing slurry as a raw material before reduction, removing unnecessary components from the slurry and drying the residues as described in Wo 2017/164376 or WO 2018/155608, or a method which includes, in addition to the above process, classification as described in Examples according to the present embodiment, followed by reducing the resulting granules or granules with controlled particle sizes. Hereinafter, a method including spray drying according to the present embodiment of the present disclosure will be described in detail below.

### Spray Drying Step

The spray drying can be performed by spraying a raw material slurry, such as a Mn—Ni-ferrite slurry, like a shower and blowing hot air onto the sprayed slurry for drying to obtain granules. The spray drying may be carried out using a spray dryer equipped with an atomizer disk, such as a rotary disk, a pin-type disk, or a Coanda disk, a two-fluid nozzle, a three-fluid nozzle, or a four-fluid nozzle. The spray medium used mainly contains water and may contain known organic substances, inorganic substances, organic metals, and other substances such as solvents, dispersants, and flocculants. The spray drying conditions, device, and other factors may be appropriately selected from those in known techniques. In general, the raw material slurry is dispersed in a drying chamber of a sprayer equipped with at least one nozzle or disk for introducing the raw material slurry and at least one airflow nozzle, followed by immediately removing the liquid phase from the raw material slurry to obtain target granules. The flow rate supplied to each disk or nozzle and the flow ratio between the disks or nozzles may also be appropriately set. Moreover, although the temperature of the drying chamber may be appropriately set depending on the composition of the raw material slurry, the rate of removing the liquid phase, and other factors, the temperature is preferably at least 80° C. but not higher than 150° C., more preferably at least 101° C. but not higher than 130° C.

The concentration of the raw material slurry such as the Mn—Ni-ferrite slurry (Mass of Raw material slurry/(Mass of Raw material slurry+Mass of Spray medium)) may be at least 3% by mass but not more than 50% by mass, preferably at least 13% by mass but not more than 45% by mass.

The granules obtained by the spray drying have an average particle size of at least 20 μm but not more than 200 μm, preferably at least 40 μm but not more than 150 μm. If the average particle size is less than 20 μm, the heat-treated granules may have a small particle size of not more than 16 μm, resulting in increased hysteresis loss. If the average particle size is more than 200 μm, the heat-treated granules may have a large particle size of 160 μm or more, resulting in increased intra-particle eddy current loss. In both cases, iron loss may be increased, which is not preferred.

### Slurry Preparation Step

The slurry used in the spray drying step can be prepared by, for example,
a slurry preparation step including preparing a slurry by dropping a basic pH adjustment solution together with an acidic solution containing Fe and X to a stirred tank equipped with a stirring impeller while stirring to form ferrite nanoparticles, wherein X represents at least one element selected from the group consisting of Ti, Mn,

Ni, Co, Zr, Hf, V, Nb, Ta, Cr, Mo, W, Cu, Zn, and Si, and the dropping time T(s) satisfies the following relationship:
T≥375000 VD^{2/3}
wherein V (m³) represents the volume of the stirred tank, and D (m) represents the diameter of the stirring impeller.

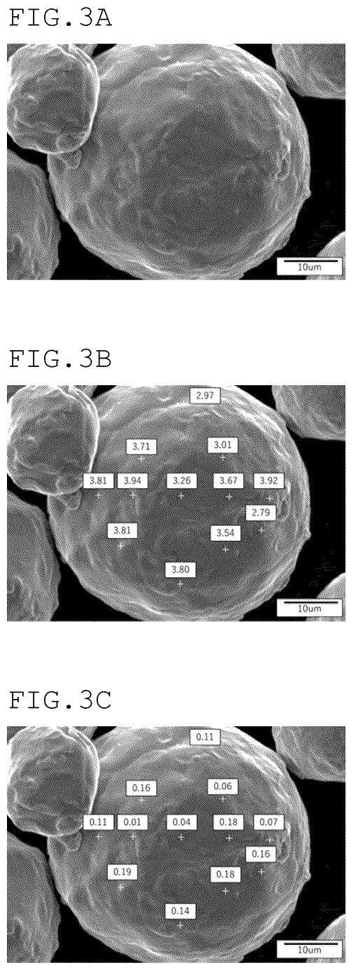

For example, a raw material slurry (Mn—Ni-ferrite slurry) may be prepared from an aqueous solution (reaction solution) containing, for example, MnSO₄.5H₂O (manganese (II) sulfate pentahydrate), NiSO₄.6H₂O (nickel (II) sulfate hexahydrate), and FeSO₄.7H₂O (iron (II) sulfate heptahydrate) using a basic (preferably of pH higher than 7 but lower than 16) pH adjuster such as a sodium hydroxide aqueous solution by a known method (as in, for example, JP 7055417 B). The reaction solution previously adjusted to an acidic range, preferably to a pH higher than −1 but lower than 7, in an appropriate amount, preferably more than 0% but less than 50% of the entire reaction solution, may be put in a reaction tank (in the present specification, also referred to as a reaction field). Then, the remaining reaction solution and the pH adjuster may be simultaneously dropped at room temperature in the air with mechanical stirring with appropriate power per unit volume and rotational speed to gradually change the pH of the solution in the reaction field from an acidic range to a basic range, thereby forming ferrite nanoparticles in the reaction field. At this time, a desired raw material slurry can be prepared by oxidizing divalent iron ions with an oxidizing agent such as atmospheric oxygen to form a divalent and trivalent mixed valence oxide. The stirring impeller used may be of a vertical type. The use of a vertical stirring impeller can efficiently introduce atmospheric oxygen into the reaction field. Here, a raw material slurry with a reduced amount of by-products such as oxides different from ferrite, hydroxides, and oxyhydroxides can be obtained by reducing the rate of dropping the reaction solution and the pH adjuster to an extent that does not cause excessive oxidation of the reaction solution. Thus, the finally produced Fe—X soft magnetic material tends to have improved magnetic properties. To prevent excessive oxidation, it is essential to reduce the stirring rate or the rotational speed of the stirring impeller, devise the shape of the stirring impeller, or reduce or stop the introduction of oxygen or air via bubbling or the dropwise addition of an oxidizing agent such as a sodium nitrite aqueous solution. Further to the above-described efforts, it is important to set the dropping time to be sufficiently long. The dropping time T(s) preferably satisfies the relationship: T≥375000 VD^{2/3}, wherein V (m³) represents the volume of the stirred tank, and D (m) represents the diameter of the stirring impeller. Meanwhile, in a document (Jun Nishitsuji, Ryoya Okazaki, Satoshi Abe, Jun Akamatsu, Nobuyoshi Imaoka, Michiya Kume, Yoshinaka Kawakami, Hiroyuki Hosokawa, and Kimihiro Ozaki, IEEE TRANSACTIONS ON MAGNETICS, VOL.59, NO.11 (2023) P.2000706), Pv is set to 0.2 kW/m³ as in WO 2017/164376, with V=0.050 and D=0.220. In this case, a dropping time of at least 116 minutes seems to be preferred, but the dropping is terminated after 15 minutes because oxidation is accelerated by air bubbling or other means. Therefore, an oxyhydroxide such as goethite is observed as shown in FIG. 3 of the above document. In contrast, in the present embodiment of the present disclosure, air bubbling as in the above document is stopped and the intake of atmospheric oxygen as an oxidizing agent is limited to that from a stirring action of a vertical stirring impeller, and the dropping time is set to 120 minutes. Therefore, a highly pure raw material slurry free from by-products such as goethite can be obtained.

### Heat Treatment Step

The heat treatment can be performed by heat-treating the resulting granules in a reducing gas to obtain a heat-treated product. The reducing gas may be appropriately selected from hydrogen (H₂), hydronitrogens such as ammonia (NH₃) and hydrazine (NH₂—NH₂), hydrocarbon gases such as carbon monoxide (CO) and methane (CH₄), etc. Hydrogen gas is preferred in terms of cost. The flow rate of the gas may be appropriately adjusted to be within a range where oxides do not scatter. Although the heat treatment temperature is at least 800° C. but not higher than 1200° C., the heat treatment temperature is preferably at least 900° C., which is higher than the α-γ transition temperature, but not higher than 1150° C., which allows the reactor to be made of hastelloy or inconel at low cost. When the heat treatment temperature is at least 800° C., the reduction of the granules can efficiently proceed. When the heat treatment temperature is not higher than 1200° C., the particle growth of the granules can be suppressed, so that a desired particle size can be maintained. The heat treatment time is preferably at least one minute but not more than 14400 minutes, more preferably at least 10 minutes but not more than 1440 minutes. If the heat treatment time is less than one minute, since the heat treatment step according to the present embodiments corresponds to an endothermic reaction, the temperature cannot reach a predetermined temperature, resulting in an insufficient reduction reaction. If the heat treatment time is more than 14400 minutes, particles with unacceptable particle growth may begin to appear.

### Slow Oxidation Step

Immediately after completion of the heat treatment step, slow oxidation is preferably performed in an atmosphere in which an inert gas is mixed to give an oxygen partial pressure lower than in the air. The slow oxidation allows the powder surface that has undergone the heat treatment step to be oxidized and passivated (i.e., t provided with a surface oxide layer of wustite, ferrite, or the like), thereby suppressing spontaneous combustion or burning caused by rapid oxidation when exposed to the air. For example, the inert gas in the atmosphere may be appropriately selected from nitrogen, noble gases such as argon, oxygen, the air, etc. To inhibit a reduction in the properties of the magnetic material, a combination of argon and oxygen is preferred. The slow oxidation temperature is preferably at least room temperature but not higher than 500° C. At higher than 500° C., the passivation of the surface of the magnetic powder may excessively proceed, resulting in lower properties of the magnetic powder. The slow oxidation time is preferably at least one minute but not more than 14400 minutes. If the slow oxidation time is less than one minute, the surface passivation may not sufficiently proceed, so that the magnetic powder may combust when taken out. If the slow oxidation time is more than 14400 minutes, excessive passivation may proceed, resulting in lower properties of the magnetic powder. The oxygen partial pressure is preferably at least 0.01% but lower than 21%, more preferably at least 0.1% but lower than 4%. If the oxygen partial pressure is lower than 0.01%, the surface passivation may not sufficiently proceed, so that the magnetic powder may combust when taken out. If the oxygen partial pressure is at least 21%, spontaneous combustion or burning caused by rapid oxidation may occur.

Moreover, the slow oxidation can also be performed by temporarily evacuating a reaction chamber and then gradually opening the chamber at room temperature to increase the oxygen concentration, thereby preventing rapid exposure to the air.

### Soft Magnetic Material

The soft magnetic material is a material with low coercivity and high saturation flux density and is not a material having a low saturation flux density like an oxide soft magnetic material such as ferrite. The soft magnetic material is a Fe—X alloy containing Fe and X, which is good in heat resistance, iron loss, and magnetic permeability, wherein X represents at least one element selected from the group consisting of Ti, Mn, Ni, Co, Zr, Hf, V, Nb, Ta, Cr, Mo, W, Cu, Zn, and Si. Moreover, the soft magnetic material can be coated as described later to allow the magnetic body to have a higher electrical resistance, lower losses, and improved magnetization and magnetic permeability.

The Fe—X alloy preferably includes a first phase containing Fe and X, and a second phase containing Fe and X with an X content that is higher than in the first phase on an atomic basis. As used herein, the term “X content” refers to the amount (atom %) of X based on the total amount of Fe and X taken as 100 atom %. The X content of the second phase is preferably at least 1.1 times but not more than 10⁵ times, more preferably at least twice but not more than 10⁵ times, the X content of the first phase.

As used herein, the X content ratio is calculated from the amounts of one identical element in both of these phases. When the X content of the second phase is within the above range, both low coercivity and high magnetization can be achieved. Such an alloy is suitable as a soft magnetic material with good high-frequency characteristics.

When X is Ti or Mn, the X content of the second phase is preferably at least twice but not more than 10⁵ times the X content of the first phase. When X is one of Zr, Hf, V, Nb, Ta, Cr, Mo, W, Cu, Zn, and Si, the X content of the second phase is preferably at least 1.5 times but not more than 10⁵ times the X content of the first phase. When X is Ni or Co, the X content of the second phase is preferably more than one time, more preferably at least 1.1 times but not more than 10⁵ times, the X content of the first phase and may be at least 1.2 times, at least 1.3 times, or at least 1.4 times the X content of the first phase. As used herein, the X content ratio is calculated from the amounts of one identical type of element in both of the phases. The X content within the above range makes it possible to achieve both low coercivity and high saturation magnetization and, for example, to obtain a soft magnetic material with a coercivity of 80 A/m or less and a saturation magnetization of at least 0.3 T. Such a soft magnetic material can be used to achieve lower losses in high-frequency applications. The Fe—X alloy can have a structure in which the nanoscale first and second phases are connected by ferromagnetic bonds due to the presence of nano-order X compositional fluctuations caused by disproportionation reactions during the heat treatment. Such a structure probably leads to low coercivity and high saturation magnetization. The Fe—X alloy can be produced by a method, for example, described in WO 2017/164376 or WO 2018/155608.

The first phase and the second phase in the Fe—X alloy contain crystals with a bcc structure containing Fe and X and therefore can improve magnetization. The crystallite size of the bcc structure in the first and second phases in the Fe—X alloy is preferably at least 1 nm but less than 100 nm. The Fe—X alloy can include additional components other than the X components. In this case, the X component content is preferably higher than the additional component content. The additional component contents in the first and second phases refer to the amounts (atom %) of additional components based on the total amount of Fe and X components including additional components, taken as 100 atom, in the first and second phases, respectively. Such a content allows both low coercivity and improved magnetization to be achieved.

Preferred among Fe—X alloys are Fe—X alloys with X being Mn (such alloys are referred to as “Fe—X (X=Mn”)), Fe—X alloys with X being Ni (such alloys are referred to as “Fe—X (X=Ni)”), and Fe—X alloys with X being Mn and Ni (such alloys are referred to as “Fe—X (X=Mn, Ni)”). Ni and Mn may be main components of X. When X=Mn, Ni, other components may be included in an amount smaller than the amount of Mn, Ni. More preferably, X consists substantially only of Mn and Ni. Here, the phrase “consists substantially only of” means that the amount of other metal components is less than 1% by mass. Fe—X (X=Mn) tends to have higher electrical resistance and heat resistance than Fe powder (pure iron) does. This is probably due to the inclusion of an X component-enriched phase. Fe—X (X=Ni) shows higher magnetization when the Ni content is higher than 0 but not higher than 12 atom %, as expected from the Slater-Pauling curve. Fe—X (X=Mn, Ni) can have the advantages of both Fe—X (X=Mn) and Fe—X (X=Ni). In other words, it is possible to increase electrical resistance and therefore reduce eddy current loss and improve heat resistance and magnetization.

The soft magnetic material obtained by the heat treatment is preferably in the form of powder because it is then easy to form a powder magnetic core of any shape, for example, to form a compact stator for an axial motor core or the like. The average particle size D₅₀ of the soft magnetic material can be, for example, at least 1 μm but not more than 5 mm, preferably at least 5 μm but not more than 1 mm, more preferably at least 10 μm but not more than 500 μm, still more preferably not more than 160 μm, further preferably not more than 130 μm. When D₅₀ is within the above range, the coercivity can be reduced and the distortion during annealing can also be reduced. In addition, such a soft magnetic material is preferred because, in particular, it provides a good balance between coercivity, which contributes to hysteresis loss, and eddy current loss, which depends on particle size, when used in stator cores for motors for applications such as next-generation mobility driven at 2 kHz or higher, including flying cars, and drones. For use in inductors or transformers for non-insulated or insulated DC-DC converters and the like for applications such as next-generation mobility driven at a frequency of at least 5 kHz but not higher than 10 kHz, D₅₀ is preferably at least 60 μm but not more than 80 μm. For use in inductors or transformers for AC-DC convertors for applications such as small adapters driven at a frequency of at least 50 KHz but not higher than 120 kHz, Do is preferably at least 16 μm but not more than 26 μm. For use in high-voltage (not higher than 50000 V) transformers, pulse transformers, or pulse inductors driven at a frequency of at least 2 kHz but not higher than 100 kHz, D₅₀ is preferably at least 18 μm but not more than 130 μm. Here, the term “average particle size D₅₀” refers to the particle size corresponding to 50% of the cumulative particle size distribution by volume of the magnetic powder determined with a dry laser diffraction particle size distribution analyzer.

A washing step is preferably performed which includes washing the magnetic material with an acidic aqueous solution to remove the impurities and oxide layer on the surface of the magnetic material. The acid compound used in the washing may be an inorganic or organic acid. Examples of the inorganic acid include sulfuric acid, hydrochloric acid, nitric acid, phosphoric acid, boric acid, and hydrofluoric acid. Examples of the organic acid include acetic acid, formic acid, oxalic acid, tartaric acid, and citric acid. The pH during the washing is preferably lower than pH 7, more preferably lower than pH 3. The washing time is preferably at least one minute but not more than 600 minutes. During the washing, the aqueous solution is preferably stirred.

### Classification Step

The heat treatment step is preferably followed by a classification step which includes classifying the soft magnetic material obtained by the heat treatment step to obtain a classified product. The classification can provide the soft magnetic material with a desired average particle size. The classification may be performed by any method, including a well-known method. Examples of such methods include sieve classification, vibration classification, hydraulic classification, and pneumatic classification. In other words, gravitational field classification, inertial field classification, centrifugal field classification, and other classifications based on any principle can be selected.

Coating step

The method preferably includes a coating step which includes coating the soft magnetic material obtained by the heat treatment step or the classification step with a silicon compound, a phosphorus compound, a magnesium compound, an aluminum compound, or other compound. In particular, the method preferably includes a phosphorus compound coating step. One of the reasons this is preferred is as follows. When a fine and moderately soft substance, such as a phosphorus compound, which is not as hard as ferrite or transition metal oxides and not too soft like resins, coats the Fe—X alloy powder or is present between the particles, it has the advantage of preventing deterioration of the inherent properties of the soft magnetic powder, such as magnetic permeability.

For example, the coating step is preferably performed by mixing an aqueous solution containing a phosphate compound and a rare earth compound with the soft magnetic material to form a coating layer containing a phosphorus compound containing a rare earth metal element on the surface of the soft magnetic material. The coating step allows the metal component in the magnetic material to react with the phosphate component in the phosphate compound, thereby forming a coating layer. The coating layer may be a coating layer containing a phosphorus compound containing a rare earth metal element or a coating layer containing a rare earth phosphate. When a coating layer containing a rare earth phosphate is formed and then heated, the resulting coating layer may contain a phosphorus compound other than phosphates depending on the combination of elements contained in the coating layer and the atmosphere during the heating after the layer formation.

Examples of the phosphate compound contained in the aqueous solution include orthophosphoric acid, sodium dihydrogen phosphate, sodium monohydrogen phosphate, ammonium dihydrogen phosphate, ammonium monohydrogen phosphate, zinc phosphate, calcium phosphate, and other phosphate-based materials, hypophosphorous acid-based materials and hypophosphites-based materials, pyrophosphoric acid-based materials, polyphosphoric acid-based materials, and other inorganic phosphoric acids, and organic phosphoric acids, and salts thereof. These may be used alone or in combinations of two or more.

The amount of the phosphate compound, calculated as PO₄, in the aqueous solution is preferably at least 0.0001% by mass but not more than 50% by mass, more preferably at least 0.001% by mass but not more than 10% by mass. In such a range, the phosphate compound tends to have high solubility in water and high storage stability.

In the coating step, the rare earth metal element derived from the rare earth compound in the aqueous solution can adhere to the magnetic material. The amount of the rare earth compound in the aqueous solution is preferably such that the amount of the rare earth metal element is at least 0.0001% by mass, more preferably at least 0.01% by mass, still more preferably at least 0.1% by mass, of the coated soft magnetic material. When the amount of the rare earth metal element in the coated soft magnetic material is at least 0.0001% by mass, the amount of the coating layer coated tends to be stable. When the amount is at least 0.01% by mass, losses tend to be further reduced. When the amount is at least 0.1% by mass, heat resistance tends to be further improved. The upper limit of the amount of the rare earth metal element in the coated soft magnetic material can be 50% by mass or less, preferably 10% by mass or less. When the amount of the rare earth metal element in the coated soft magnetic material is 50% by mass or less, a decrease in the magnetic permeability of the coated soft magnetic material can be reduced, which can inhibit a decrease in characteristics. The rare earth metal element can precipitate as a phosphorus compound containing a rare earth metal element or a rare earth-containing phosphate on the surface of the magnetic material.

A rare earth metal element tends to have a small Gibbs energy change (ΔG) for the oxidation reaction in the temperature range (at least about 400° C. but not higher than about 700° C.) where the coated soft magnetic material is heated. Thus, the use of a rare earth compound in the coating step can result in a coated soft magnetic material with good heat resistance. The Gibbs energy changes for oxidation reactions at 600° C. of rare earth oxides are shown in Table 1.

TABLE 1

| Element | ΔG for oxidation at 600° C. [kJ/mol O₂] |
|---|---|
| Ce | −907.9 |
| La | −1028.5 |
| Nd | −1039.9 |
| Sm | −1046.5 |
| Dy | −1069.1 |

The rare earth compound contains a rare earth metal element. The rare earth metal element is preferably Ce, Nd, Sm, La, Dy, Y, or Pr, more preferably Ce, Nd, Sm, La, or Dy, still more preferably Ce, Sm, La, or Dy, particularly preferably Sm or Dy. The rare earth compound is preferably a compound that generates rare earth ions in an aqueous solution, such as a rare earth oxide, a rare earth hydroxide, a rare earth chloride, a rare earth sulfate, a rare earth nitrate, or a rare earth acetate, more preferably a rare earth chloride. Specific examples of preferred rare earth compounds include chlorides of at least one rare earth element selected from the group consisting of Ce, Nd, Sm, La, and Dy. These may be used alone or in combinations of two or more. Because rare earth chlorides tend to dissolve readily, the use of a rare earth chloride makes it easier to obtain the aqueous solution used in the coating step.

The amount of the rare earth compound in the aqueous solution containing the phosphate compound and the rare earth compound is preferably at least 0.001% by mass but not more than 10% by mass, more preferably at least 0.01% by mass but not more than 5% by mass. When the amount is within the above range, the rare earth compound tends to have high solubility in water and high storage stability.

The reaction time taken to form a coating layer on the surface of the magnetic material is preferably at least one minute but not more than 600 minutes, more preferably at least five minutes but not more than 120 minutes.

Examples of the reaction solvent used in the coating step include water and solvent mixtures of water and hydrophilic organic solvents. When these solvents are used, a smaller particle size phosphate may precipitate to form a denser coating layer than when hydrophobic organic solvents are used. Water is preferred among the solvents mentioned above. When a solvent mixture of water and a hydrophilic organic solvent is used, the hydrophilic organic solvent may be ethanol, methanol, 2-propanol, acetone, or 2-butanone. The amount of the hydrophilic organic solvent in the solvent mixture is preferably at least 0.1% by mass but not higher than 80% by mass, more preferably at least 1% by mass but not higher than 50% by mass.

In the coating step, the pH of the aqueous solution may increase as more phosphate derived from the phosphate compound adheres to the magnetic material. In this case, the pH of the aqueous solution may be adjusted by adding an inorganic acid or an organic acid. When the pH is adjusted, the pH range can be higher than 0 but lower than 7, preferably at least 1 but not higher than 4.5, more preferably at least 1.6 but not higher than 3.9, still more preferably at least 2 but not higher than 3. When the pH is at least 1, the precipitation rate of the phosphorus compound containing a rare earth metal element can be reduced as compared to when the pH is lower than 1, and the thickness of the coating layer to be formed can be easily controlled. When the pH is at least 7, the amount of the precipitated phosphate tends to decrease, resulting in insufficient coating and increased losses. Thus, the pH is preferably lower than 7. When the pH is not higher than 4.5, the precipitation rate of the phosphate can be not too low. Examples of the inorganic acid include sulfuric acid, hydrochloric acid, nitric acid, phosphoric acid, boric acid, and hydrofluoric acid. Examples of the organic acid include acetic acid, formic acid, oxalic acid, and tartaric acid. Although an inorganic acid is preferably used in view of liquid waste disposal, an organic acid may be used together depending on the purpose. An inorganic acid and an organic acid may be used in admixture. When the pH is adjusted, the inorganic or organic acid may be added as needed to adjust the pH within the above-mentioned range during the coating step. In the coating step, because the pH initially increases rapidly, the inorganic or organic acid for pH control is preferably introduced at short intervals.

In the coating step, the amount of the magnetic material in the mixture of the magnetic material and the aqueous solution containing the phosphate compound and the rare earth compound can be at least 0.0001% by mass but not more than 70% by mass, preferably at least 0.01% by mass but not more than 10% by mass. When the amount is within the above range, the thickness of the coating layer tends to be stable.

To improve the water resistance and corrosion resistance of the coating and the magnetic properties of the magnetic powder, additives may also be added including, for example, oxoacid salts such as molybdates, tungstates, vanadates, and chromates; oxidizing agents such as sodium nitrate and sodium nitrite; and chelating agents such as EDTA. When the aqueous solution contains an oxoacid salt, the concentration thereof in the aqueous solution is preferably at least 0.0001% by mass but not higher than 10% by mass, more preferably at least 0.01% by mass but not higher than 1% by mass. When the aqueous solution contains an oxidizing agent, the concentration thereof in the aqueous solution is preferably at least 0.0001% by mass but not higher than 10% by mass, more preferably at least 0.01% by mass but not higher than 1% by mass. When the aqueous solution contains a chelating agent, the concentration thereof in the aqueous solution is preferably at least 0.0001% by mass but not higher than 10% by mass, more preferably at least 0.01% by mass but not higher than 1% by mass.

In the coating step, the components may be mixed in any order as long as an aqueous solution containing the phosphate compound and the rare earth compound can be ultimately mixed with the soft magnetic material. In the coating step, preferably, an aqueous solution containing the rare earth compound is firstly mixed with the magnetic material and then with the phosphate compound. Mixing the aqueous solution containing the rare earth compound with the magnetic material in advance allows the rare earth compound to easily adhere or bind to the surface of the magnetic material, making it possible to increase the amount of the coating layer containing a phosphorus compound. When the aqueous solution containing the rare earth compound is mixed with the magnetic material in advance, the mixture obtained by mixing them may be stirred preferably at a pH of at least 2 but not higher than 12, more preferably at a pH of at least 4 but not higher than 10, still more preferably at a pH of at least 5 but not higher than 8, preferably for at least one minute, more preferably at least five minutes, before adding an aqueous solution containing the phosphate compound.

The coating step may be performed only once or may be performed at least twice. By performing the coating step at least twice, a thick coating layer containing a phosphorus compound containing a rare earth metal element can be formed on the surface of the magnetic material. The upper limit of the number of times the coating step is performed can be, for example, 10 or less, and may be five or less. The number of times the coating step is performed may also be two.

When the coating step is performed at least twice, the magnetic material may be purified between the coating step and the next coating step. The magnetic material on which a coating layer is formed can be purified, for example, by heating at a temperature of at least 100° C. but not higher than 800° C. or by filtration with a filter.

When the coating step is performed at least twice, the aqueous solution used in the n-th coating step is preferably obtained by adding the rare earth compound to the aqueous solution used in the (n-1)th coating step. In this case, the n-th coating step can be performed without purifying the magnetic material after the (n-1)th coating step. n is an integer of at least 2, but when the coating step is performed k times, n is preferably any integer of at least 2 but not more than k. When n is any integer of at least 2 but not more than k, an aqueous solution obtained by adding the rare earth compound to the aqueous solution used in the coating step is used in each of the second and subsequent coating steps.

The type of the rare earth compound added to the aqueous solution used in the n-th coating step may be the same as or different from the rare earth compound in the aqueous solution used in the (n-1)th coating step.

The concentration of the rare earth compound added to the aqueous solution used in the n-th coating step may be selected appropriately according to the reaction time of the (n-1) th coating step and the type of the rare earth compound. The concentration of the rare earth compound added to the aqueous solution used in the n-th coating step is preferably at least 0.01 times but not more than 50 times, more preferably at least 0.1 times but not more than 10 times, the rare earth compound content in the aqueous solution used in the (n-1)th coating step. In such a range, the thickness unevenness of the coating layer can be reduced.

When the coating step is performed at least twice, the pH of the mixture of the aqueous solution and the magnetic material obtained in the m-th coating step is preferably lower than the pH of the mixture of the aqueous solution and the magnetic material obtained in the (m-1)th coating step, and the difference therebetween is preferably at least 0.1, more preferably at least 1. Here, as the reaction between the phosphate compound and the magnetic material proceeds, the free phosphate content in the aqueous solution may decrease, so that the pH of the mixture of the aqueous solution and the magnetic material may increase. If the pH fluctuates during the reaction, the pH of the mixture of the aqueous solution and the magnetic material obtained in the (m-1)th coating step refers to the pH at the end of the (m-1)th coating step. When the pH of the mixture of the aqueous solution and the magnetic material obtained in the m-th coating step is lower than that in the (m-1)th coating step, the efficiency of forming a coating layer containing a phosphorus compound on the magnetic material can be improved.

m is an integer of at least 2, but when the coating step is performed k times, m may be any integer of at least 2 but not more than k. When m is any integer of at least 2 but not more than k, an aqueous solution with a pH lower than the pH of the mixture of the aqueous solution and the magnetic material obtained in the previous coating step is used in each of the second and subsequent coating steps. Alternatively, when k is at least 3, the pH in the first coating step may be different from the pH in the second coating step, and the pH in the third and subsequent coating steps may be adjusted to be in the same pH range as in the second coating step.

In the m-th coating step, the pH of the aqueous solution may be adjusted by adding an inorganic acid or an organic acid. When the pH is adjusted, the pH range can be higher than 0 but lower than 7, preferably at least 1 but not higher than 4.5, more preferably at least 1.6 but not higher than 3.9, still more preferably at least 2 but not higher than 3. When the pH is at least 1, the precipitation rate of the phosphorus compound containing a rare earth metal element can be reduced as compared to when the pH is lower than 1, and the thickness of the coating layer to be formed can be easily controlled. When the pH is at least 7, the amount of precipitated phosphate tends to decrease, resulting in insufficient coating and increased losses. Thus, the pH is preferably lower than 7. When the pH is not higher than 4.5, the precipitation rate of phosphate can be not too low. The acid to be added may be an inorganic acid or an organic acid. Examples of the inorganic acid include sulfuric acid, hydrochloric acid, nitric acid, phosphoric acid, boric acid, and hydrofluoric acid. Examples of the organic acid include acetic acid, formic acid, oxalic acid, tartaric acid, and citric acid. Although an inorganic acid is preferably used in view of liquid waste disposal, an organic acid may be used together depending on the purpose. An inorganic acid and an organic acid may be used in admixture. When the pH is adjusted, the inorganic or organic acid may be added as needed to adjust the pH within the above-mentioned range during the coating step. In the coating step, as the pH initially increases rapidly, the inorganic or organic acid for pH control is preferably introduced at short intervals.

An inorganic acid or an organic acid may be added to the aqueous solution to adjust the pH within the range of at least 1 but not higher than 4.5 for at least one minute. To reduce the thin parts of the coating, this pH adjustment is preferably performed for at least 30 minutes. In the pH maintenance, as the pH initially increases rapidly, the inorganic or organic acid for pH control is preferably introduced at short intervals. Then, as the coating proceeds, pH fluctuations gradually decrease, which allows the inorganic or organic acid to be introduced at longer intervals. This allows one to determine the end point of the reaction.

The n-th coating step may also serve as the m-th coating step. In other words, the pH adjustment in the m-th coating step may be performed in the n-th coating step.

The coating step may be followed by coating with an aqueous solution containing a phosphate compound and a non-rare earth metal element compound. In this case, the method of producing a coated soft magnetic material preferably includes the above-described coating step as a primary coating step, followed by a secondary coating step including mixing an aqueous solution containing a phosphate compound and a non-rare earth metal element compound with the resulting magnetic material to form a coating layer containing phosphate and the non-rare earth metal element on the surface of the magnetic material. The amount of the coating layer containing phosphorus formed on the surface of the magnetic material can be increased by performing the secondary coating step. Performing the secondary coating step also allows the rare earth metal element to be localized on the side of the coating layer closer to the magnetic material.

The type and concentration of the phosphate compound in the aqueous solution used in the secondary coating step are as described above for the coating step. The non-rare earth metal element may be one other than rare earth metal elements. Examples include metal elements other than rare earth metal elements, and metalloid elements. Examples of the metal elements other than rare earth metal elements include alkali metal elements such as Li, Na, K, Rb, and Cs; alkaline earth metal elements such as Ca, Sr, and Ba; transition metal elements such as Ti, Zr, Hf, V, Nb, Ta, Cr, Mo, W, Mn, Fe, Ru, Co, Ni, Pd, Pt, Cu, Ag, and Au; and typical elements such as Zn, Cd, and Al. Examples of the metalloid elements include B, Al, Si, and Ge. Among these, metal elements are preferred. In order to obtain a coated soft magnetic material with good heat resistance, metal elements each of which have a Gibbs energy change (ΔG) for the oxidation reaction that is −300 KJ/mol 02 or less in the temperature range (at least about 400° C. but not higher than about 700° C.) where the coated soft magnetic material is heated are more preferred. Transition metals are still more preferred, with Cr, W, Mn, Mo, Nb, and V being particularly preferred. Table 2 shows the Gibbs energy changes for oxidation reactions at 600° C. of oxides of metals other than rare earth elements.

TABLE 2

| Element | ΔG for oxidation at 600° C. [kJ/mol O₂] |
|---|---|
| Cu | −212.4 |
| Ni | −320.2 |
| W | −416.2 |
| Fe | −420.2 |
| Mo | −432.9 |
| K | −482.7 |
| Zn | −523.6 |
| Cr | −599.1 |
| Na | −596.4 |
| Mn | −641.8 |
| Ta | −666.0 |
| Nb | −675.2 |
| V | −709.6 |
| Si | −752.5 |
| Ti | −900.0 |
| Zr | −931.7 |
| Hf | −910.8 |
| Ba | −933.4 |
| Al | −934.8 |
| Mg | −1014.9 |
| Ca | −1086.9 |

Examples of the non-rare earth metal element compound include oxoacids, heteroacids, chlorides, hydroxides, nitrides, oxides, borides, fluorides, nitrates, phosphates, sulfates, and silicates of non-rare earth metal elements, with oxoacids being preferred. Oxoacids may be polyacids. Among these, metal oxoacid compounds are preferred, transition metal oxoacid compounds are more preferred, and Cr, W, Mn, Mo, Nb, and V oxoacid compounds are still more preferred. The non-rare earth metal element compounds listed above may be used alone or in combinations of two or more. The non-rare earth metal element compound content in the aqueous solution used in the secondary coating step is preferably at least 0.001% by mass but not more than 10% by mass, more preferably at least 0.01% by mass but not more than 5% by mass.

In the secondary coating step, the reaction time taken to form a coating layer on the surface of the magnetic material is preferably at least one minute but not more than 10 hours, more preferably at least five minutes but not more than 120 minutes.

In the secondary coating step, an inorganic

acid or an organic acid is preferably added to the aqueous solution to adjust the pH. When the pH is adjusted, the pH range can be higher than 0 but lower than 7, preferably at least 1 but not higher than 4.5, more preferably at least 1.6 but not higher than 3.9, still more preferably at least 2 but not higher than 3. When the pH is at least 1, the precipitation rate of phosphate can be reduced as compared to when the pH is lower than 1, and the thickness of the coating layer to be formed can be easily controlled. When the pH is at least 7, the amount of precipitated phosphate tends to decrease, resulting in insufficient coating and increased losses. Thus, the pH is preferably lower than 7. When the pH is not higher than 4.5, the precipitation rate of phosphate can be not too low. The acid to be added may be an inorganic acid or an organic acid. Examples of the inorganic acid include sulfuric acid, hydrochloric acid, nitric acid, phosphoric acid, boric acid, and hydrofluoric acid. Examples of the organic acid include acetic acid, formic acid, oxalic acid, tartaric acid, and citric acid. Although an inorganic acid is preferably used in view of liquid waste disposal, an organic acid may be used together depending on the purpose. An inorganic acid and an organic acid may be used in admixture. When the pH is adjusted, the inorganic or organic acid may be added as needed to adjust the pH within the above-mentioned range during the coating step. In the coating step, as the pH initially increases rapidly, the inorganic or organic acid for pH control is preferably introduced at short intervals.

An inorganic acid or an organic acid may be added to the aqueous solution to adjust the pH within the range of at least 1 but not higher than 4.5 for at least one minute. To reduce the thin parts of the coating, this pH adjustment is preferably performed for at least 30 minutes. In the pH maintenance, as the pH initially increases rapidly, the inorganic or organic acid for pH control is preferably introduced at short intervals. Then, as the coating proceeds, pH fluctuations gradually decrease, which allows the inorganic or organic acid to be introduced at longer intervals. This allows one to determine the end point of the reaction.

A purification step for the coated soft magnetic material may be performed after the coating step and optionally the secondary coating step described above. In the purification step for the coated soft magnetic material, the liquid component can be removed, for example, by heating at a temperature of at least 100° C. but not higher than 500° C., filter filtration, ceramic membrane filtration, suction filtration, or centrifugal separation.

A coating layer stabilization step may also be performed after the coating step and optionally the secondary coating step described above. In the coating layer stabilization step, the purified coated soft magnetic material may be treated at a high temperature so that the phosphorus is baked onto the magnetic material. The temperature conditions of the high temperature treatment are preferably at least 50° C. but not higher than 500° C., more preferably at least 100° C. but not higher than 300° C. The high temperature treatment time is preferably at least one minute but not more than 6000 minutes, more preferably at least 10 minutes but not more than 600 minutes.

### Soft Magnetic Material

A soft magnetic material according to the present embodiment includes a first phase and a second phase each including crystals with a bcc structure containing Fe and X, wherein X represents at least one element selected from the group consisting of Ti, Mn, Zr, Hf, V, Nb, Ta, Cr, Mo, W, Cu, Zn, and Si, at least one element of the at least one element represented by X is contained in both the first phase and the second phase, the amount of one of the element in the second phase is at least twice but not more than 10⁵ times the amount of the one of the element in the first phase, and the soft magnetic material has an average circularity of at least 0.55 and an average particle size of 160 μm or less.

In another example, a soft magnetic material according to the present embodiment includes a first phase and a second phase each including crystals with a bcc structure containing Fe and X, wherein X represents at least one transition metal selected from the group consisting of Ni and Co, at least one element of the at least one transition metal represented by X is contained in both the first phase and the second phase, the amount of the element in the second phase is more than one time but not more than 10⁵ times the amount of the element in the first phase, and the soft magnetic material has an average circularity of at least 0.55 and an average particle size of 160 μm or less.

The soft magnetic material according to the present embodiment can be produced by, for example, the method of producing a soft magnetic material according to the embodiments described above. The composition of the soft magnetic material, the content ratio of the at least one element as X contained in both phases, the average particle size, and other conditions are as described for the soft magnetic material obtained by heat treatment. X is preferably Mn and/or Ni.

Although the average circularity of the soft magnetic material is at least 0.55, it is preferably at least 0.6, more preferably at least 0.65 or at least 0.70. Here, the upper limit of the circularity is 1. The soft magnetic material having a circularity closer to 1 is preferred because the contact between such powder particles is close to point contact, resulting in reduced inter-particle eddy current loss. The percentage of particles with a circularity of at least 0.8 may be at least 30% by mass, preferably at least 40% by mass, more preferably at least 50% by mass. The circularity is an index of how close the contour of a particle is to a circle. The closer the contour is to circle, the closer the circularity is to 1. Here, the circularity can be determined from the area S of a cross-section of a particle and the perimeter L of the particle using the following equation:

$$Circularity = 4 π S / {L}^{2} .$$

The average degree of necking of the soft magnetic material having an average particle size of 160 μm or less may be 4 or lower, preferably 3 or lower, more preferably 2 or lower. Here, when particles show no necking and have an average particle size equal to the projected particle size, and a very small dispersion in particle size distribution, the degree of necking is extremely close to 1. The degree of necking is an index of the degree of aggregation of particles. If no powder particles are connected and/or in contact with each other due to aggregation, then the degree of necking is close to 1. If all powder particles are connected and/or in contact with each other due to aggregation, then the degree of necking is practically infinite when discussing high-frequency characteristics, but it is actually a finite value that is extremely large compared to 4.

The degree of necking can be determined from D₅₀ measured using a dry laser diffraction particle size distribution analyzer and d₅₀ (referred to as the projected particle size) using the equation below, where d₅₀ is the number average particle size of parts recognizable as particles by observing an image of aggregates of powder particles projected onto a plane perpendicular to the imaging direction in an SEM image of a “part sufficiently representing” the entire powder particles. Here, the “part sufficiently representing” means that it is necessary to analyze a sufficient number of powder particles to be considered at least “representative”, in principle, 30 powder particles.

$$Degree of necking = {D}_{50} / {d}_{50}$$

In the present disclosure, the degree of necking is defined with respect to powder aggregates having an average particle size of 160 μm or less. This means the following. Powder particles of 160 μm or less are likely to cause aggregation-induced necking. In this case, aggregates of particles with, for example, a degree of necking of 4 or lower can be easily subjected to any coating treatment to produce a molded product with reduced inter-particle eddy current loss. Even if they are molded without a coating treatment, the electrical connection between the particles can be loosened, and in this case, the inter-particle eddy current loss can also be relatively reduced, resulting in good iron loss. In contrast, in the case of aggregates of particles having an average particle size of more than 160 μm, even if the equation for the degree of necking is applied to these aggregates to obtain a degree of necking of 4 or the like, high intra-particle eddy current loss remains, though the inter-particle eddy current loss is admittedly reduced. Consequently, they cannot exhibit good iron loss.

The degree of necking increases not only when the particle size of the primary particles is small, but also when the soft magnetic powder particles coagulate or sinter to connect with each other, depending on the heat treatment conditions of the raw material granules and other factors. Moreover, the degree of necking greatly varies depending on the particle shape and the surface conditions. Particles shaped to have many flat surfaces tend to have an increased degree of necking.

From the perspective of reducing iron loss, the soft magnetic material having D₅₀ of 160 μm or less and a high circularity preferably has a low span, where the span is one of the indices of particle size distribution defined as follows:

$$Span = ( {D}_{90} - {D}_{10} ) / {D}_{50} .$$

The span may be 1 or less, 0.5 or less, or 0.4 or less.

The standard deviation of the particle size distribution of particles with the same D₅₀ is preferably small from the perspective of reducing iron loss. In particular, in the case of particles with D₅₀ of 160 μm or less, the standard deviation of the particle size distribution may be preferably 80 μm or less, more preferably 50 μm or less, still more preferably 30 μm or less.

A magnetic material having D₅₀ of at least 16 μm, a narrow particle size distribution (i.e., a particle size distribution with a small span and a small standard deviation), and a low degree of necking has a small number of coordination bonds between the particles and a low possibility of connection between the magnetic powder particles and thus tends to have both low inter-particle and intra-particle eddy currents and therefore low losses. In particular, since pulse transformers and the like, which need to avoid electrical breakdown and the like, do not require a high filling ratio, they are one of the applications where a narrow particle size distribution has an advantageous effect. Here, a magnetic material that has small D₅₀ but has a wide particle size distribution and thus has a high volume fraction of particles larger than the D₅₀ is not preferable because the eddy current loss will be significant at the target frequency defined by the D₅₀. Moreover, a magnetic material that has a wide particle size distribution and therefore a high volume fraction of particles smaller than the D₅₀ is not preferable because the contact between the particles increases, and the inter-particle eddy current loss and the hysteresis loss at the target frequency will be significant.

### Coated Soft Magnetic Material

A coated soft magnetic material according to the present embodiment includes a soft magnetic material and a silicon compound coating layer containing a silicon-containing compound (containing silica or a silicate) and/or a phosphorus compound coating layer containing a rare earth metal element, phosphorus, and oxygen, provided on the surface of the soft magnetic material. The coating layer can contain a phosphorus compound containing a rare earth metal element, and the phosphorus compound may be a phosphate. The coating layer may contain an oxide free from any rare earth metal element. In this case, the phosphorus compound containing a rare earth metal element may not be a phosphate. Examples of the rare earth metal element include Ce, Nd, Sm, La, Dy, Y, and Pr, with Ce, Nd, Sm, La, and Dy being preferred. The term “coated soft magnetic material” is not limited to a soft magnetic material fully coated, but may be partially coated. Here, the method for coating the silicon-containing compound is described. Examples include known methods, such as a method that includes introducing a polysilazane compound onto the powder surface and thermally decomposing it in the air to remove an ammonium component, thereby forming a silica layer, and a method that includes introducing a silicon resin onto the powder interface and thermally decomposing it to remove an organic component, thereby forming a silica interface.

The average particle size of the coated soft magnetic material is as described for the soft magnetic material. The thickness of the coating layer containing a rare earth metal element, phosphorus, and oxygen is preferably at least 2 nm but not more than 10 μm, more preferably at least 5 nm but not more than 500 nm, from the perspective of the insulating properties and heat resistance of the coated soft magnetic material. The thickness of the coating layer can be measured by compositional analysis using an EDX line scan of a cross-section of the coated soft magnetic material.

In the coating layer, oxygen is preferably present in a larger amount than phosphorus. In this case, there is at least a region where oxygen is present in a larger amount than phosphorus in the thickness direction of the coating layer. The region where oxygen is present in a larger amount than phosphorus preferably accounts for at least 10%, more preferably at least 50%, still more preferably the entire region, in the thickness direction of the coating layer. The oxygen content is preferably more than 1 times the phosphorus content, and may be at least two times or at least three times the phosphorus content. The upper limit of the oxygen content can be, for example, not more than 10 times the phosphorus content.

The coating layer may further contain a non-rare earth metal element other than phosphorus and oxygen in addition to the rare earth metal element, phosphorus, and oxygen. Examples of the non-rare earth metal element other than phosphorus and oxygen include metal elements other than rare earth metal elements, metalloid elements, H, C, N, O, F, P, S, Cl, Br, and I. Examples of the metal elements other than rare earth metal elements include alkali metal elements such as Li, Na, K, Rb, and Cs, alkaline earth metal elements such as Ca, Sr, and Ba, transition metal elements such as Fe, Ti, Zr, Hf, V, Nb, Ta, Cr, Mo, W, Mn, Ru, Co, Ni, Pd, Pt, Cu, Ag, and Au, and typical elements including zinc group metals and earth metals, such as Zn, Cd, and Al. Examples of the metalloid elements include B, Al, Si, and Ge. Preferred among these are metal elements. In order to obtain a coated soft magnetic material with good heat resistance, metal elements each of which have a Gibbs energy change (ΔG) for the oxidation reaction that is −300 KJ/mol O₂ or less in the temperature range (at least about 400° C. but not higher than about 700° C.) where the coated soft magnetic material is heated are more preferred. Transition metals are still more preferred, with Cr, W, Mn, Mo, Nb, and V being particularly preferred. These elements, when present in the coating layer, may be derived from the magnetic material to be coated, or may be elements that were present during the coating formation reaction.

When the coating layer contains a non-rare earth metal element other than phosphorus and oxygen, the non-rare earth metal element and the rare earth metal element are preferably present in the coating layer such that, in the direction from the surface of the coating layer toward the magnetic material, the non-rare earth metal element shows the maximum amount, and then the rare earth metal element shows the maximum amount. In this case, the insulating properties tend to improve. When the thickness of the coating layer is T, the distance between the position with the maximum amount of the non-rare earth metal element and the position with the maximum amount of the rare earth metal element in the direction from the surface of the coating layer toward the magnetic material is preferably at least 0.001×T but not more than 0.99×T, more preferably at least 0.1×T but not more than 0.9×T. The insulating properties tend to further improve in the range of at least 0.1×T but not more than 0.9×T.

Preferably, after the non-rare earth metal element shows the maximum amount, its amount decreases and then turns into an increase in the direction from the surface of the coating layer toward the magnetic material. With such a distribution, the heat resistance of the coating layer tends to improve. A coating layer can be formed such that the amount of the non-rare earth metal element has such a distribution by performing the coating step at least twice and adding an inorganic acid to the aqueous solution used in the second or subsequent coating step to adjust the pH to at least 1 but not higher than 4.5. The minimum amount of the non-rare earth metal element decreasing after showing the maximum amount but before turning into an increase is preferably not more than 0.9 times, more preferably not more than 0.5 times, the maximum amount. The lower limit of the minimum amount can be at least 0.001 times the maximum amount.

In the coating layer, each of the above elements may be present in either crystalline or amorphous form. Moreover, the concentration (atom %) of each element in the coating layer can be measured by compositional analysis using an EDX line scan of the coated soft magnetic material. The presence of a phosphate compound or a composite oxide in microcrystalline form in the coating can increase mechanical strength and improve heat resistance.

The soft magnetic material included in the coated soft magnetic material can be as described above for the method of producing a coated soft magnetic material.

The rare earth metal element content in the coated soft magnetic material is preferably at least 0.0001% by mass, more preferably at least 0.01% by mass, still more preferably at least 0.1% by mass. When the rare earth metal element content is at least 0.0001% by mass, the coated soft magnetic material tends to be resistant to heat treatment at high temperatures. When the rare earth metal element content is at least 0.01% by mass, the coated soft magnetic material tends to be resistant to heat treatment at higher temperatures. When the rare earth metal element content is at least 0.1% by mass, the resulting coated soft magnetic material tends to have further improved insulating properties. The upper limit of the rare earth metal element content can be 50% by mass or less, preferably 10% by mass or less. When the rare earth metal element content in the coated soft magnetic material is 50% by mass or less, the decrease in the magnetic permeability of the coated soft magnetic material can be reduced, and the decrease in the characteristics can be reduced. The rare earth metal element content in the coated soft magnetic material can be measured by ICP atomic emission spectroscopy (ICP-AES).

The phosphorus content in the coated soft magnetic material is preferably at least 0.0001% by mass but not higher than 15% by mass, more preferably at least 0.001% by mass but not higher than 5% by mass. In the above range, the heat resistance tends to improve. The phosphorus content in the coated soft magnetic material can be measured by ICP-AES.

A molded product of a soft magnetic material according to the present embodiment can be produced from the soft magnetic material according to the present embodiments as described later.

The molded product of the soft magnetic material may have an average anisotropic particle size of 95 μm or less, preferably 90 μm or less, more preferably 80 μm or less, where the average anisotropic particle size is the average of the anisotropic particle sizes (Ra) represented by the following equation in a cross-sectional image of the molded product of the soft magnetic material.

$${R}_{a} = {( 4 S / \prod )}^{0.5} / A$$

In the equation, S represents the area of a particle constituting the molded product, and A represents the aspect ratio of the particle. A smaller average anisotropic particle size is preferred because then the intra-particle eddy current loss can be smaller and the molded product can be magnetically isotropic. The lower limit is not limited, but when only particles having a cross-sectional area of 50 μm-or more are measured, as in EXAMPLES of the present disclosure, the average anisotropic particle size tends to be at least 8 μm. The average anisotropic particle size is the number average anisotropic particle size determined in a cross-section of the molded product and is preferably the average of Ra measurements of at least 30 particles.

The molded product containing the coated soft magnetic material can have an iron loss W_{10/2k} of 300 W/kg or less, preferably 280 W/kg or less, more preferably 200 W/kg or less. The lower limit of the iron loss W may be at least 20 W/kg. The coated soft magnetic material can have a hysteresis loss Wₕ of 180 W/kg or less, preferably 150 W/kg or less, more preferably 130 W/kg or less. The lower limit of the hysteresis loss Wₕ may be at least 19 W/kg. The coated soft magnetic material can have an eddy current loss Wₑ of 220 W/kg or less, preferably 120 W/kg or less, more preferably 45 W/kg or less. The lower limit of the eddy current loss Wₑ may be at least 1 W/kg. Here, these losses are measured at a maximum flux density Bₘₐₓ=1 T and a frequency of 2 kHz as described in EXAMPLES.

Moreover, when measured at Bₘₐₓ=0.5 T and a frequency of 5 kHz, the iron loss W_{5/5k} can be 400 W/kg or less, preferably 300 W/kg or less, more preferably 150 W/kg or less. The lower limit of the iron loss W may be at least 25 W/kg. Under these conditions, the hysteresis loss Wₕ of the coated soft magnetic material can be 150 W/kg or less, preferably 140 W/kg or less, more preferably 110 W/kg or less. The lower limit of the hysteresis loss Wₙ may be at least 24 W/kg. Under these conditions, the eddy current loss Wₑ of the coated soft magnetic material can be 200 W/kg or less, preferably 165 W/kg or less, more preferably 50 W/kg or less. The lower limit of the eddy current loss We may be at least 1 W/kg.

When measured at Bₘₐₓ=0.5 T and a frequency of 10 kHz, the iron loss W_{5/10k} can be 1000 W/kg or less, preferably 950 W/kg or less, more preferably 400 W/kg or less. The lower limit of the iron loss W may be at least 50 W/kg. Under these conditions, the hysteresis loss Wₕ of the coated soft magnetic material can be 300 W/kg or less, preferably 280 W/kg or less, more preferably 220 W/kg or less. The lower limit of the hysteresis loss Wₕ may be at least 48 W/kg. Under these conditions, the eddy current loss Wₑ of the coated soft magnetic material can be 700 W/kg or less, preferably 650 W/kg or less, more preferably 180 W/kg or less. The lower limit of the eddy current loss We may be at least 1 W/kg.

The molded product containing the coated soft magnetic material may have a flux density (B₁₀₀) at 10000 A/m of at least 1.1 T, at least 1.2 T, at least 1.3 T, or at least 1.4 T, preferably at least 1.5 T.

According to the present embodiments, the molded product that has undergone a heating step can have such numerical ranges. The heating temperature in the heating step can be 600° C., for example. The molded product with an iron loss W and other losses within such numerical ranges may contain no resin or glass. When the coated soft magnetic material, not the molded product, has undergone the heating step, the iron loss W, hysteresis loss Wₕ, and eddy current loss Wₑ of the coated soft magnetic material measured may be in the ranges described above.

### Method of Producing Molded Product

The soft magnetic material obtained by the method of producing a soft magnetic material according to the embodiments can be heated and molded (heating step) to produce a molded product.

The heating temperature is preferably at least 100° C. but not higher than 1200° C. The heating step can be performed, for example, in order to eliminate strain caused by pressurization or to partially react the coating layer of the coated soft magnetic material to obtain an integrated molded product. To eliminate strain caused by pressurization, the heating temperature is preferably at least 300° C. but not higher than 1000° C., more preferably at least 400° C. but not higher than 700° C. Since the coated soft magnetic material obtained by coating the soft magnetic material has a coating layer with good thermal stability, the lack of the coating layer can be reduced even after the heating step. The heating temperature may be at least 500° C. In this case, the molded product preferably contains no resin or glass. This is because resins and glass are likely to degrade significantly at high temperatures of at least 500° C. The duration of the heating step is preferably at least one minute but not more than 6000 minutes, more preferably at least 10 minutes but not more than 600 minutes. The heating step may be performed in a nitrogen atmosphere or in the air, for example. The heating step is preferably performed in an inert atmosphere such as an argon atmosphere or in vacuum. Heating in a nitrogen atmosphere may nitride the magnetic material, deteriorating the characteristics. Thus, the heating step is preferably performed in an inert atmosphere other than a nitrogen atmosphere.

The heating is preferably preceded by obtaining a pressure molded product by pressurizing the coated soft magnetic material. In this case, the heating step means heating the pressure molded product obtained in the step of obtaining a pressure molded product. The step may include, for example, a hot press method performed by heating under pressure or a hot isostatic press (HIP) method.

The pressurization conditions are preferably at least 0.01 GPa but not higher than 10 GPa, more preferably at least 0.5 GPa but not higher than 5 GPa. A mold can be filled with the coated soft magnetic material and then pressurized to obtain a pressure molded product of the desired shape. When a mold is used, a lubricant, which will be described later, may be applied to the inner wall of the mold cavity before filling with the coated soft magnetic material. Applying a lubricant to the inner wall of the mold cavity can improve the releasability of the pressure molded product from the mold.

During the pressurization, the coated soft magnetic material may be pressurized alone or may be mixed with a binder, a lubricant, etc. and then pressurized. Examples of the binder include thermosetting resins such as epoxy resins, urethane resins, phenol resins, methacrylic resins, acrylic resins, and silicone resins, and thermoplastic resins such as polyamide resins and thermoplastic silicone resins. The amount of the binder used per 100 parts by mass of the coated soft magnetic material is preferably at least 0.01 parts by mass but not more than 1000 parts by mass, more preferably at least one part by mass but not more than 50 parts by mass. When the amount of the binder used is within the above range, a molded product with good mechanical strength and low losses such as iron loss can be obtained.

Examples of the lubricant include metallic soaps such as zinc stearate, calcium stearate, and lithium stearate, amines or amides such as 1,2-bis(stearoylamino)ethane, long chain hydrocarbons such as waxes, silicone oils, and fluorine-containing compounds. The amount of the lubricant used per 100 parts by mass of the coated soft magnetic material is preferably at least 0.00001 parts by mass but not more than 10 parts by mass, more preferably at least 0.01 parts by mass but not more than five parts by mass. When the amount of the lubricant used is within the above range, the releasability of the pressure molded product from the mold cavity can be improved.

The filling ratio of the molded product obtained by the above-described production method can be at least 10% but not higher than 100%, preferably at least 80% but not higher than 100%. The filling ratio here refers to the ratio (percentage) of the molded product density to the true density. The ratio (percentage) of the volume of the coated soft magnetic material to the volume of the molded product obtained according to the present embodiments may be at least 40% but not higher than 100%, preferably at least 80% but not higher than 100%. The ratio of the area of the coated soft magnetic material to the area of the molded product in a cross-section of a portion of the molded product may be regarded as the ratio of the volume of the coated soft magnetic material to the volume of the molded product.

Since the molded product obtained by the production method is an assembly with the coated soft magnetic material having a coating layer with good thermal stability, the coating layer is maintained after the heating step, and the losses such as iron loss can be reduced. After the heating step, the coating layers of the individual coated soft magnetic material particles may partially react to fuse and integrate with the coating layers of the adjacent coated soft magnetic material particles while maintaining the insulation between the magnetic material particles. Such a molded product can be produced from the coated soft magnetic material without using a binder such as a resin or glass. Resins can give rise to eddy currents when carbonized by heating. Glass may also be deteriorated by heating. For these reasons, when a binder such as a resin or glass is used, the temperature of heating, if performed, is preferably relatively low. In the case of a molded product containing no resin or glass, even when heated at a relatively high temperature such as 500° C. or higher, an increase in losses can be reduced. Moreover, heating at a relatively high temperature can more effectively eliminate strain caused by pressurization. Furthermore, the combined use with the lubricant described above can increase the molded product density and allow the adjacent coated soft magnetic material particles to be bonded by a chemical reaction, thereby improving mechanical strength.

### Application

The molded product can be used as a powder magnetic core with reduced iron loss in various applications. The molded product can be applied, for example, to transformers, coils, heads, inductors, reactors, cores (magnetic cores), yokes, various actuators, etc. The molded product can also be used as a soft magnetic component to be incorporated into any of various motors, such as motors for rotating machines and linear motors. Examples of the motors for rotating machines include voice coil motors, induction motors, reluctance motors, and axial motors. In particular, the molded product is effective as a stator core of an axial motor capable of being driven at 2 kHz or higher.

The soft magnetic material according to the present embodiment and the molded product produced from the soft magnetic material exhibit high effects when applied not only to axial motors but also to high-frequency (2 kHz or higher), high-speed rotating devices, systems, equipment, etc.

The present inventors have studied intensively the relationship between the frequency f (kHz) used in the applied equipment and the average particle size with good iron loss. As a result, they found the following relationship:

$$r = 184 \times {f}^{- 0.5}$$

where r represents the average particle size of the magnetic material according to the present disclosure.

Thus, when the soft magnetic material according to one embodiment of the present disclosure having an average particle size of 184 f^{-0.5 μ}m is applied to equipment used at a frequency f (kHz), the iron loss, particularly the intra-particle eddy current loss, of the magnetic material is reduced.

The average particle size r is 130 at f=2, r is 80 at f=5, and r is 60 at f=10.

### EXAMPLES

Examples are described below. It should be noted that “%” is by mass unless otherwise specified.

### Comparative Example 1

An aqueous solution with a pH of 3.5 was prepared from MnSO₄.5H₂O (manganese (II) sulfate pentahydrate), NiSO₄.6H₂O (nickel (II) sulfate hexahydrate), and FeSO₄.7H₂O (iron (II) sulfate heptahydrate) as raw materials at an atomic concentration ratio of Fe:Ni:Mn=97.9:2.0:0.1. A portion of the aqueous solution having a sulfate concentration of 0.84 mol/L was added to a stirred tank equipped with a stirring impeller (the volume V of the stirred tank: 0.051 (m³), the diameter D of the stirring impeller: 0.220 (m)). The remaining aqueous solution and a pH adjuster with a pH of 15.2 containing a NaOH aqueous solution were dropped into the stirred tank with stirring to obtain a Mn—Ni-ferrite slurry. Here, the power P_{V} per unit volume was 0.2 kW/m3 and the dropping time was 120 minutes. The slurry was subjected to suction filtration and hot air drying at 50° C. to obtain Mn—Ni-ferrite granules. The XRD pattern of the granules indicated that the resulting Mn—Ni-ferrite had an almost single phase. The granules were classified as having a particle size of 63 to 125 μm. The classified granules were placed in a hydrogen atmosphere and heated to 300° C. at a rate of 10° C./min and maintained for 30 minutes, then heated to 450° C. at a rate of 10° C./min and maintained for 30 minutes, then heated to 750° C. at a rate of 10° C./min, to 950° C. at a rate of 5° C./min, then to 1050° C. at a rate of 5° C./min, and heat-treated in a hydrogen atmosphere for 75 minutes. Thereafter, the granules were rapidly cooled to room temperature and then subjected to slow oxidation in an argon atmosphere at an oxygen partial pressure of 3% by volume for 30 minutes to obtain a soft magnetic powder. The soft magnetic powder was disintegrated in a cutter mill and then classified using a sieve. The powder remaining on the sieve with an aperture of 150 μm was used as a Fe—Ni—Mn soft magnetic powder of Comparative Example 1. The obtained Fe—Ni—Mn soft magnetic powder had D₅₀ of 300 μm. The Fe—Ni—Mn powder was coated with a silicon compound by a known method of mixing with a polysilazane compound and an organic solvent and heating the mixture to obtain a silicon compound-coated soft magnetic material of Comparative Example 1.

### Example 1

The same procedure as in Comparative Example 1 was followed, except that the powder passing through the sieve with an aperture of 150 μm but remaining on a sieve with an aperture of 100 μm was used as a Fe—Ni—Mn soft magnetic powder. The obtained Fe—Ni—Mn soft magnetic powder had D₅₀ of 146 μm. The powder was coated with a silicon compound as in Comparative Example 1 to obtain a coated soft magnetic material of Example 1.

### Example 2

The same procedure as in Comparative Example 1 was followed, except that the powder passing through a sieve with an aperture of 100 μm but remaining on a sieve with an aperture of 53 μm was used as a Fe—Ni—Mn soft magnetic powder. The obtained Fe—Ni—Mn soft magnetic powder had D₅₀ of 93 μm. The powder was coated with a silicon compound as in Comparative Example 1 to obtain a coated soft magnetic material of Example 2.

### Example 3

The same procedure as in Comparative Example 1 was followed, except that the powder passing through a sieve with an aperture of 53 μm was used as a Fe—Ni—Mn soft magnetic powder. The obtained Fe—Ni—Mn soft magnetic powder had D₅₀ of 57 μm. The powder was coated with a silicon compound as in Comparative Example 1 to obtain a coated soft magnetic material of Example 3.

### Example 4

A Mn—Ni-ferrite slurry was obtained as in Comparative Example 1. The slurry was condensed to a solute concentration of at least 12%, and the resulting slurry was spray-dried at a temperature of 100° C. and an atomizer rotational speed of 6000 rpm to obtain Mn—Ni-ferrite granules. The granules were placed in a hydrogen atmosphere and heated to 300° C. at a rate of 10° C./min and maintained for 30 minutes, then heated to 450° C. at a rate of 10° C./min and maintained for 30 minutes, then heated to 750° C. at a rate of 10° C./min, to 950° C. at a rate of 5° C./min, then to 1050° C. at a rate of 5° C./min, and heat-treated in a hydrogen atmosphere for 75 minutes. Thereafter, the granules were rapidly cooled to room temperature and then subjected to slow oxidation in an argon atmosphere at an oxygen partial pressure of 3% by volume for 30 minutes to obtain a soft magnetic powder. The soft magnetic powder was disintegrated in a cutter mill and then sieved. The powder passing through a sieve with an aperture of 150 μm but remaining on a sieve with an aperture of 100 μm was used. The obtained Fe—Ni—Mn powder had D₅₀ of 154 μm.

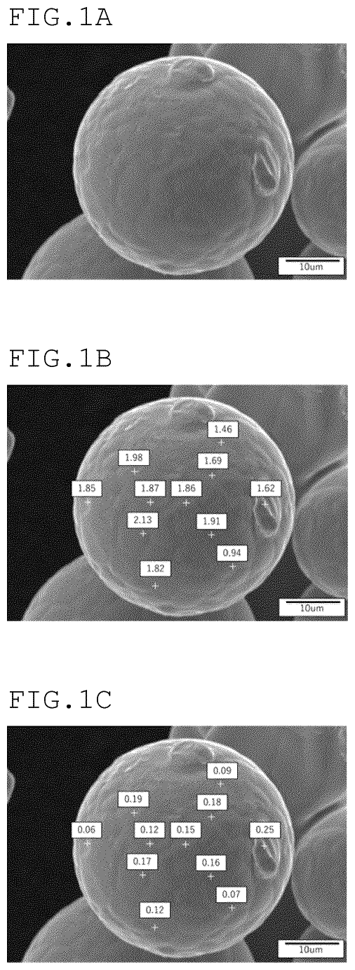

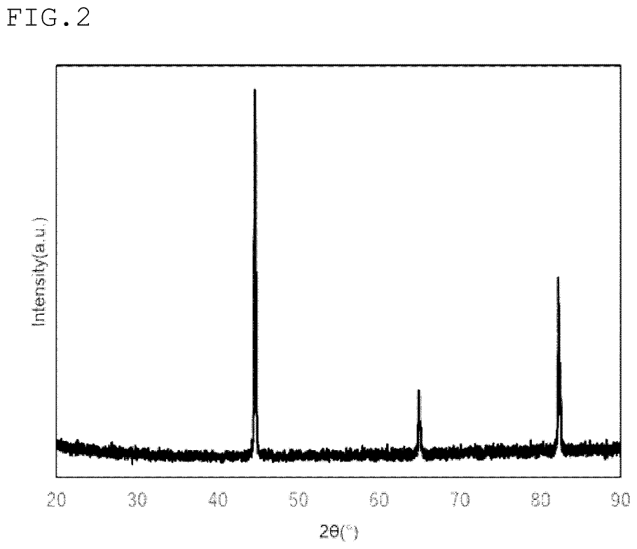

FIG. 1A shows an SEM image of the Fe—Ni—Mn soft magnetic powder taken from the top, FIG. 1B shows SEM-DEX results of Ni in that image area, FIG. 1C shows SEM-EDX results of Mn, and FIG. 2 shows an XRD pattern. In the SEM-EDX, the calculation was made so that the total atomic concentration of Fe, Ni, and Mn was 100%. FIG. 1B demonstrated the presence of a second phase (a phase with 1.46 to 2.13 atom %) having a Ni content that is more than one time but not more than 10⁵ times the Ni content of a first phase (a phase with 0.94 atom %) or even a second phase (a phase with 1.46 to 2.13 atom %) having a Ni content that is at least 1.1 times but not more than 10⁵ times the Ni content of the first phase. Moreover, FIG. 1C demonstrated the presence of a second phase (a phase with 0.12 to 0.25 atom %) having a Mn content that is more than twice but not more than 10⁵ times the Mn content of a first phase (a phase with 0.06 atom %). Moreover, FIG. 2 demonstrated that the soft magnetic powder has a bcc structure. These results indicate that the first and second phases for X=Ni and the first and second phases for X=Mn of the soft magnetic powder all have a bcc structure.

Then, the Fe—Ni—Mn soft magnetic powder was coated with a silicon compound as in Comparative Example 1 to obtain a coated soft magnetic material of Example 4.

### Example 5

The same procedure as in Example 4 was followed, except that the powder passing through the sieve with an aperture of 100 μm and remaining on a sieve with an aperture of 53 μm was used. The obtained Fe—Ni—Mn soft magnetic powder had D₅₀ of 99 μm. The powder was coated with a silicon compound as in Comparative Example 1 to obtain a coated soft magnetic material of Example 5.

### Example 6

The same procedure as in Example 4 was followed, except that powder passing through a sieve with an aperture of 53 μm in the classification was used. The obtained Fe—Ni—Mn soft magnetic powder had D₅₀ of 53 μm. The powder was coated with a silicon compound as in Comparative Example 1 to obtain a coated soft magnetic material of Example 6.

### Comparative Example 2

The same procedure as in Comparative Example 1 was followed, except that the slurry was adjusted to have an atomic concentration ratio of Fe:Ni:Mn=95.9:4.0:0.1, and the powder passing through a sieve with an aperture of 300 μm was used as a Fe—Ni—Mn soft magnetic powder. The obtained Fe—Ni—Mn soft magnetic powder was coated with a phosphorus compound through the following steps.

### (i) Washing of Soft Magnetic Material

Fifty grams of the soft magnetic material was added to an aqueous solution adjusted to a pH of 1.1 or lower with dilute hydrochloric acid and then stirred for 10 minutes to remove the surface oxide layer and contaminants.

### (ii) Coating Step

An aqueous solution containing samarium chloride in an amount of 8% by mass relative to the soft magnetic material was added to the washed soft magnetic material and then stirred for 15 minutes. Next, an aqueous solution containing sodium molybdate in an amount of 2.9% by mass relative to the soft magnetic material and an aqueous phosphate solution with a pH of 2 containing orthophosphoric acid and sodium dihydrogen phosphate in an amount of 4% by mass relative to the soft magnetic material were added and then stirred for 7 minutes. The final concentrations of the components were as follows: soft magnetic material: 16.6% by mass, samarium chloride: 0.001% by mass, and phosphate compound (calculated as PO₄): 0.01% by mass. The pH of the treatment tank increased from 3 to 5.

(iii) pH Adjustment Step

An aqueous solution containing samarium chloride in an amount of 8% by mass relative to the coated soft magnetic material was added, and the reaction mixture was stirred for 30 minutes while controlling the pH of the reaction mixture within a range of 2.5±0.1 by introducing 6% by mass hydrochloric acid as needed.

### (iv) Drying and Baking

The coated soft magnetic material after the pH adjustment step was dried by heating in vacuum at 100° C. for four hours. Subsequently, the coated soft magnetic material was heated at 200° C. for four hours to bake the coating layer.

### Example 7

A soft magnetic powder was obtained as in Example 4, except that the slurry was adjusted to have an atomic concentration ratio of Fe:Ni:Mn=95.9:4.0:0.1, and the solute concentration of the Mn—Ni-ferrite slurry was 25%. The soft magnetic powder was disintegrated in a cutter mill and classified using a sieve with an aperture of 53 μm. The obtained Fe—Ni—Mn soft magnetic powder had D₅₀ of 51.9 μm.

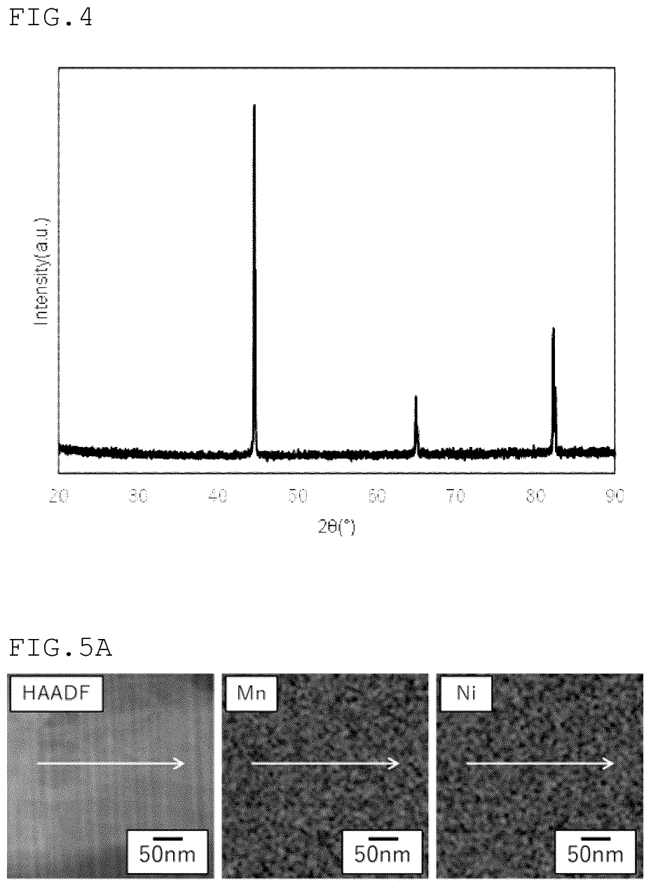

FIG. 3A to FIG. 3C show an SEM image of the Fe—Ni—Mn soft magnetic powder taken from the top and SEM-DEX results of Ni and Mn in that image area, respectively, and FIG. 4 shows an XRD pattern. In the SEM-EDX, the calculation was made so that the total atomic concentration of Fe, Ni, and Mn was 100% as in Example 2. FIG. 3B demonstrated the presence of a second phase (a phase with 2.97 to 3.94 atom %) having a Ni content that is more than one time but not more than 10⁵ times the Ni content of a first phase (a phase with 2.79 atom %) or even a second phase (a phase with 3.26 to 3.94 atom %) having a Ni content that is at least 1.1 times but not more than 10⁵ times the Ni content of the first phase. Moreover, FIG. 3C demonstrated the presence of a second phase (a phase with 0.06 to 0.19 atom %) having a Mn content that is more than twice but not more than 10⁵ times the Mn content of a first phase (a phase with 0.01 atom %). Moreover, FIG. 4 demonstrated that the soft magnetic powder has a bcc structure. These results indicate that the first and second phases for X=Ni and the first and second phases for X=Mn of the soft magnetic powder all have a bcc structure.

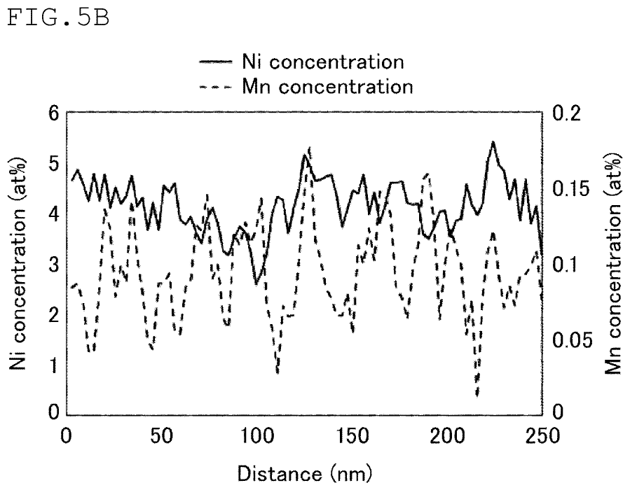

The element concentration distribution of a cross-section of the powder was measured on a sample sectioned by focused ion beam (FIB) using STEM (FEI, model No. Talos F200X, acceleration voltage: 200 kV) and STEM-EDX (system: FEI, model No. SuperX, detector: Bruker, SDD detector) attached to the STEM. FIG. 5A and FIG. 5B show the measurement results. In the obtained EDX mapping images, concentration conversion was performed so that the average intensities of Ni and Mn in each pixel (2.84 nm×2.84 nm) were equivalent to the concentrations of Ni and Mn (Ni: 4 atom %, Mn: 0.1 atom %), respectively, in the powder determined by ICP-AES. Then, line profiles were created to determine the continuous atomic concentration changes. FIG. 5B shows that there are a first phase having a Ni content of 2.5 atom % (minimum value) and a second phase having a Ni content of 5.5 atom % (maximum value), and the Ni content of the second phase is more than one time, or even at least 1.1 times, the Ni content of the first phase. Moreover, FIG. 5B shows that there are a first phase having a Mn content of 0.01 atom % (minimum value) and a second phase having a Mn content of 0.18 atom % (maximum value), and the Mn content of the second phase is at least twice the Mn content of the first phase.

Then, the Fe—Ni—Mn soft magnetic powder was coated with a phosphorus compound as in Comparative Example 2 to obtain a coated soft magnetic material of Example 7.

The Fe—Ni—Mn soft magnetic powders prepared in the examples and comparative examples were evaluated as described below. Tables 3 to 5 show the evaluation results.

### Average Particle Size

The average particle size (D₅₀), D₁₀, D₉₀, and standard deviation of the soft magnetic powder were measured using a laser diffraction particle size distribution analyzer (Japan Laser Corporation, HELOS & RODOS).

Circularity The magnetic material was dispersed and cured

in an epoxy resin or the like and then polished to expose cross-sections of the particles, followed by imaging with an electron microscope. The obtained cross-sectional image of the particles was used to determine the average circularity (C50) and the percentage by number (P80) of magnetic bodies with a circularity of at least 0.8 from the areas and perimeters of the cross-sections of the particles using image processing software, provided that the data were limited to particles having a diameter of at least 5 μm (to avoid erroneous measurements due to contamination or other reasons).

### Projected Particle Size, Degree of Necking

The magnetic material was dispersed on a carbon tape, followed by imaging with an electron microscope. The obtained particle image was used to determine the equivalent circle diameter of parts whose interior and exterior were recognizable as being divided by continuous line segments for a number “sufficiently representing this powder group”, and the number average of the diameters was calculated to determine the projected particle size (d₅₀). Subsequently, the volume average particle size (D₅₀) was determined using a dry laser diffraction particle size distribution analyzer (Japan Laser Corporation, HELOS&RODOS). The degree of necking (degree of necking=volume average particle size/projected particle size) was calculated from the D₅₀ and d₅₀ values.

### Hysteresis Loss, Eddy Current Loss, Iron Ross, Flux Density at 10000 A/m

The coated soft magnetic material was charged into a mold having an inner diameter of 10 mm and an outer diameter of 14 mm and then molded under a pressure of 980 MPa, followed by heating at 600° C. in an Ar atmosphere for one hour to prepare a toroidal molded product. The molded product was wound with a copper wire by 50 turns on the primary side and 50 turns on the secondary side to give an evaluation specimen. The evaluation specimen was evaluated for the iron losses W_{10/2k} (iron loss (W/kg) at 2 kHz and 1 T), W_{5/5k} (iron loss (W/kg) at 5 kHz and 0.5 T), and W_{5/10k} (iron loss (W/kg) at 10 kHz and 0.5 T) using an AC B-H analyzer (SY-8218, Iwatsu Electric Co., Ltd.). At the same time, the iron loss was measured at a flux density of 1 T over a range of 10 Hz to 100 Hz and at a flux density of 0.5 T over a range of 400 Hz to 800 Hz. Then, a dual-frequency method was used to determine the hysteresis losses W_{h10/2k}, W_{h5/5k}, and W_{h5/10k} (W/kg) and eddy current losses W_{e10/2k}, W_{e5/5k}, and W_{e5/10k} (W/kg) at the respective flux densities and frequencies.

The flux density (B₁₀₀ (T)) at 10000 A/m of the evaluation specimen was also evaluated using a DC B-H analyzer (BH-1000, Denshijiki Industry Co., Ltd.).

### Average Anisotropic Particle Size

The coated soft magnetic material was charged into a mold with an outer diameter of 5.5 mm and molded under a pressure of 980 MPa, followed by heating in an Ar atmosphere at 600° C. for one hour to prepare a disk-shaped molded product. The molded product was impregnated with an epoxy resin and then polished to expose a mirror-finished surface, followed by imaging of a cross-section of the molded product with an electron microscope. The obtained cross-sectional image was used to determine the diameter and aspect ratio of the particles from the cross-sections of the particles constituting the molded product, provided that the data were limited to particles of at least 50 μm² (to avoid erroneous measurements due to contamination or other reasons). Then, Ra was calculated, and its average value was determined.

TABLE 3

| | | | | | Standard | | Projected | | |
|---|---|---|---|---|---|---|---|---|---|
| | D50 | D10 | D90 | (D90 − | deviation | | particle size | Degree of | |
| | (μm) | (μm) | (μm) | D10)/D50 | (μm) | C50 | (μm) | necking | P80 |
| Comparative | 300 | 187 | 426 | 0.80 | 88.9 | 0.61 | 84.6 | — | 0.30 |
| Example 1 | | | | | | | | | |
| Comparative | 180 | 82 | 327 | 1.36 | 86.3 | 0.53 | 54.4 | — | 0.08 |
| Example 2 | | | | | | | | | |
| Example 1 | 146 | 98 | 147 | 0.33 | 40.4 | 0.57 | 27.0 | 5.4 | 0.16 |
| Example 2 | 93 | 59 | 93 | 0.37 | 33.0 | 0.56 | 26.6 | 3.5 | 0.10 |
| Example 3 | 57 | 36 | 57 | 0.37 | 18.5 | 0.57 | 24.3 | 2.3 | 0.10 |
| Example 4 | 154 | 109 | 154 | 0.29 | 43.1 | 0.67 | 39.3 | 3.9 | 0.40 |
| Example 5 | 99 | 67 | 99 | 0.33 | 26.4 | 0.74 | 38.6 | 2.6 | 0.52 |
| Example 6 | 52 | 35 | 52 | 0.33 | 15.4 | 0.74 | 36.5 | 1.4 | 0.61 |
| Example 7 | 54 | 36 | 54 | 0.34 | 25.1 | 0.67 | 30.9 | 1.7 | 0.37 |

TABLE 4

| | Hysteresis | Eddy | Iron | Hysteresis | Eddy | Iron | Hysteresis | Eddy | Iron | |
|---|---|---|---|---|---|---|---|---|---|---|
| | loss | current | loss | loss | current | loss | loss | current | loss | |
| | W_{h10/2k} | loss W_{e10/2k} | W_{10/2k} | W_{h5/5k} | loss (W_{e5/5k}) | (W_{5/5K}) | (W_{h5/10k}) | loss (W_{e5/10k}) | (W_{5/10k}) | B100 |
| | (W/Kg) | (W/Kg) | (W/Kg) | (W/Kg) | (W/Kg) | (W/Kg) | (W/Kg) | (W/Kg) | (W/Kg) | (T) |
| Comparative | 128.9 | 217.2 | 346.1 | 118.3 | 289.1 | 407.4 | 236.6 | 1041.5 | 1278.1 | 1.49 |
| Example 1 | | | | | | | | | | |
| Example 1 | 162.6 | 113.8 | 276.5 | 134.4 | 160.4 | 294.8 | 268.9 | 632.7 | 901.6 | 1.51 |
| Example 2 | 154.4 | 73.5 | 227.9 | 126.0 | 97.6 | 223.5 | 251.9 | 387.9 | 639.8 | 1.42 |
| Example 3 | 176.6 | 47.0 | 223.6 | 148.9 | 54.8 | 203.7 | 297.8 | 211.2 | 509.0 | 1.17 |
| Example 4 | 132.7 | 69.9 | 202.6 | 107.9 | 95.4 | 203.3 | 215.7 | 357.2 | 572.9 | 1.54 |
| Example 5 | 123.1 | 40.1 | 163.2 | 100.2 | 48.8 | 148.9 | 200.3 | 171.3 | 371.6 | 1.37 |
| Example 6 | 140.1 | 15.2 | 155.2 | 107.2 | 23.6 | 130.8 | 214.4 | 84.5 | 298.9 | 1.34 |

TABLE 5

| | | Eddy | | | Eddy | |
|---|---|---|---|---|---|---|
| | Hysteresis | current | Iron | Hysteresis | current | Iron |
| | loss | loss | loss | loss | loss | loss |
| | (W_{h5/5k}) | (W_{e5/5k}) | (W_{5/5k}) | (W_{h5/10k}) | (W_{e5/10k}) | (W_{5/10k}) |
| Comparative | 129.8 | 446.6 | 576.4 | 259.6 | 1540.0 | 1799.6 |
| Example 2 | | | | | | |
| Example 7 | 133.1 | 8.5 | 141.6 | 266.2 | 43.3 | 309.5 |

TABLE 6

| | Comparative | Comparative | | | | | | | |
|---|---|---|---|---|---|---|---|---|---|
| | Example 1 | Example 2 | Example 1 | Example 2 | Example 3 | Example 4 | Example 5 | Example 6 | Example 7 |
| Average | 99 | 208 | 74 | 66 | 62 | 65 | 78 | 52 | 37 |
| anisotropic | | | | | | | | | |
| particle | | | | | | | | | |
| size (μm) | | | | | | | | | |

The smaller the particle size, the lower the eddy current loss under all conditions, resulting in reduced iron loss as well. The results also show that, in Examples 2, 3, and 5 to 7 using a powder with an average particle size of 130 μm or less, the iron loss W_{5/5k} was 230 W/kg or less, which is smaller than that in Comparative Example 1 with an average particle size of 300 μm.

It is shown that all the soft magnetic powders in Examples 1 to 7 had a span ((D₉₀−D₁₀)/D₅₀) of 0.4 or less and a standard deviation σ of 50 μm or less, indicating a small percentage of large particles which can cause intra-particle eddy currents. Thus, these soft magnetic powders had low eddy current loss and therefore low iron loss.

It is shown that the soft magnetic materials produced via spray drying in Examples 4 to 6 had a higher circularity than those having a comparable particle size in Examples 1 to 3 and also had a degree of necking close to 1. Accordingly, these soft magnetic materials had low eddy current loss and therefore low iron loss. Further, the soft magnetic materials in Examples 4 to 6 contained at least 30% of particles with a circularity of at least 0.8. This is another reason for their very good high-frequency characteristics.

The soft magnetic powders in Examples 2, 3, and 5 to 7 are Fe—X soft magnetic materials having a particle size of 130 μm or less, which are particularly effective as stator cores of axial motors for use in next-generation mobility driven at 2 kHz or higher. Moreover, the soft magnetic powders in Examples 6 and 7 are Fe—X soft magnetic materials having a particle size of 60 μm or less, which are particularly effective as starter cores of axial motors for use in next-generation mobility driven at 5 kHz or higher and further as inductors or transformers of non-insulated or insulated DC-DC converters for use in next-generation mobility driven at a frequency of at least 5 kHz but not higher than 10 kHz.

The molded products of the soft magnetic powders in Examples 1 to 7 include particles having Ra of 90 μm or less, a small particle size, and a small aspect ratio. Thus, they have reduced eddy current loss and are magnetically isotropic and are therefore particularly effective as stator cores of axial motors with three-dimensional magnetic circuits, and inductors or transformers of DC-DC converters.

What is claimed is:

1. A method of producing a soft magnetic material, comprising:
spray drying a slurry containing Fe and X to obtain granules having an average particle size in a range of at least 20 μm but not more than 200 μm, wherein X represents at least one element selected from the group consisting of Ti, Mn, Ni, Co, Zr, Hf, V, Nb, Ta, Cr, Mo, W, Cu, Zn, and Si; and
heat-treating the granules in a reducing gas at a temperature in a range of at least 800° C. but not higher than 1200° C. to obtain a heat-treated product.

2. The method of producing a soft magnetic material according to claim 1, wherein the slurry is prepared by a procedure comprising dropping a basic pH adjustment solution together with an acidic solution containing Fe and X to a stirred tank equipped with a stirring impeller for a dropping time T(s) while stirring to form ferrite nanoparticles, wherein the dropping time T(s) satisfies the following relationship:
T≥375000 VD^{2/3},
wherein V (m³) represents a volume of the stirred tank, and D (m) represents a diameter of the stirring impeller.

3. The method of producing a soft magnetic material according to claim 1, further comprising
classifying the heat-treated product to obtain a classified product.

4. The method of producing a soft magnetic material according to claim 3, further comprising:
coating a surface of the classified product with a coating layer containing a phosphorus compound containing a rare earth metal element by mixing the classified product with an aqueous solution containing a phosphate compound and a rare earth compound.

5. A soft magnetic material, comprising a first phase and a second phase each comprising crystals with a bcc structure containing Fe and X, wherein
X represents at least one element selected from the group consisting of Ti, Mn, Zr, Hf, V, Nb, Ta, Cr, Mo, W, Cu, Zn, and Si,
at least one element of the at least one element represented by X is contained in both the first phase and the second phase,
an amount of one of the at least one element in the second phase is at least twice but not more than 10⁵ times an amount of the one of the at least one element in the first phase,
the soft magnetic material has an average circularity in a range of at least 0.55 and an average particle size in a range of 160 μm or less.

6. The soft magnetic material according to claim 5, wherein X includes Mn.

7. A soft magnetic material, comprising a first phase and a second phase each comprising crystals with a bcc structure containing Fe and X, wherein
X represents at least one element selected from the group consisting of Ni and Co,
at least one element of the at least one element represented by X is contained in both the first phase and the second phase,
an amount of one of the at least one element in the second phase is more than one time but not more than 10⁵ times an amount of the one of the at least one element in the first phase,
the soft magnetic material has an average circularity in a range of at least 0.55 and an average particle size in a range of 160 μm or less.

8. The soft magnetic material according to claim 5, wherein the average particle size of the soft magnetic material is 130 μm or less.

9. The soft magnetic material according to claim 5,
wherein a degree of necking of the soft magnetic material is not higher than 4.

10. The soft magnetic material according to claim 5,
wherein a percentage by number of particles with a circularity being at least 0.8 in the soft magnetic material is at least 30%.

11. The soft magnetic material according to claim 5, wherein the average circularity of the soft magnetic material is at least 0.6.

12. The soft magnetic material according to claim 5,
wherein the soft magnetic material is for use at a frequency f (kHz) of 2 kHz or higher and has an average particle size of 184 f^{-0.5} μm or less.

13. A material, comprising the soft magnetic material according to claim 5; and a coating comprising a silicon compound or a phosphate compound.

14. A soft magnetic material molded product, produced from the soft magnetic material according to claim 5, the soft magnetic material having an average anisotropic particle size that is 90 μm or less as determined from a cross-sectional image of the molded product.

15. A stator core of an axial motor capable of being driven at 2 kHz or higher, the stator core comprising the soft magnetic material according to claim 5.

16. The soft magnetic material according to claim 7, wherein the average particle size of the soft magnetic material is 130 μm or less.

17. The soft magnetic material according to claim 7, wherein a degree of necking of the soft magnetic material is not higher than 4.

18. The soft magnetic material according to claim 7,
wherein a percentage by number of particles with a circularity being at least 0.8 in the soft magnetic material is at least 30%.

19. The soft magnetic material according to claim 7, wherein the average circularity of the soft magnetic material is at least 0.6.

20. The soft magnetic material according to claim 7,
wherein the soft magnetic material is for use at a frequency f (kHz) of 2 kHz or higher and has an average particle size that is 184 f^{-0.5} μm or less.

21. A material, comprising the soft magnetic material according to claim 7; and a coating comprising a silicon compound or a phosphate compound.

22. A soft magnetic material molded product, produced from the soft magnetic material according to claim 7, the soft magnetic material having an average anisotropic particle size being 90 μm or less as determined from a cross-sectional image of the molded product.

23. A stator core of an axial motor capable of being driven at 2 kHz or higher, the stator core comprising the soft magnetic material according to claim 7.
